(19) United States
(12) Patent Application Publication
(10) Pub. No.: US 2008/0082818 A1
(43) Pub. Date: Apr. 3, 2008

(54) SYMMETRIC KEY-BASED AUTHENTICATION IN MULTIPLE DOMAINS

(76) Inventors: Geon Woo KIM, Daejeon-city (KR); Jong-Wook HAN, Daejeon-city (KR); Kyo-Il CHUNG, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/856,924

(22) Filed: Sep. 18, 2007

(30) Foreign Application Priority Data
Sep. 29, 2006 (KR) 10-2006-0096588

(51) Int. Cl. H04L 9/32

(52) U.S. Cl. 713/156

(57) ABSTRACT

An authentication method capable of securing reliability and scalability by authenticating an authentication entity using a certificate signed by a symmetric key, when a user or device accesses a domain in which an authentication process is required are provided. The method includes: (a) allowing a home domain authentication server to generate a certificate and a symmetric key and to distribute the certificate and the symmetric key to an authentication entity; (b) allowing the authentication entity to submit the certificate to the home domain authentication server or an external domain authentication server; and (c) allowing the home domain authentication server or external domain authentication server to verify the validity of the submitted certificate by using the symmetric key. Accordingly, an effective authentication method can be provided in a public key-based authentication method in consideration of data processing capability or computing power.

### CROSS-REFERENCE TO RELATED PATENT APPLICATION

This application claims the benefit of Korean Patent Application No. 10-2006-0096588, filed on Sep. 29, 2006, in the Korean Intellectual Property Office, the disclosure of which is incorporated herein in its entirety by reference.

### BACKGROUND OF THE INVENTION

1. Field of the Invention

The present invention relates to authenticating an authentication entity by using a certificate signed by a symmetric key in a multiple domain environment which has different authentication subjects. Specifically, there is provided an authentication method which achieves reliability and scalability by using the certificate signed by the symmetric key, when a user or device desired to be authenticated accesses a domain in which an authentication process is required.

This work was supported by the IT R&D program of MIC/IITA [2006-S-067-01, the development of security technology based on device authentication for ubiquitous home network.]

2. Description of the Related Art

Generally, in a multiple domain environment based on a public network, an X.509-based certificate using a public key is used. The certificate including the public key is provided in a public directory. A certificate signature is performed by an high level certification authority which issues the corresponding certificate. Thus, an authentication structure having scalability is supported through the hierarchical authentication method. However, it is difficult for the authentication entity having low processing capability and computing power to use the public key-based authentication, in consideration of a feature of a public key-based password process.

IP security (IPsec) and Return Routability (RR) protocols are used as protocols for protecting node-to-node communication in a mobile IPv6 environment defined by the Internet Engineering Task Force (IETF). There is a problem that a method of effectively authenticating an ID has not been suggested. A certificate-based method has an advantage in scalability and disadvantages in embodying a public key infrastructure (PKI) and distributing a certificate. On the contrary, the ID-based authentication method has an advantage in embodying a PKI and distributing a certificate and a disadvantage in scalability. A hybrid method obtained by combining the two aforementioned methods can support scalability at low cost. However, the hybrid method has to concurrently use the certificate-based method using the public key and the ID-based authentication method. The hybrid method has an object of managing an IPsec key in the mobile IPv6. On the contrary, the aforementioned method cannot provide a method that can be used for user/device authentication in a multiple domains such as a ubiquitous computing environment, in which an authentication entity provides only a symmetric key-based authentication method, and only the public key-based authentication method can be used among higher level servers.

### SUMMARY OF THE INVENTION

The present invention provides a new authentication method capable of solving scalability and efficiency that are disadvantages of a symmetric key method and enabling a light-weighted authentication entity, which is suitable for a multiple domain environment having different authentication subjects.

The present invention also provides an apparatus capable of solving scalability and efficiency that are disadvantages of a symmetric key method and enabling a light-weighted authentication entity, in a multiple domain environment which has different authentication subjects.

According to an aspect of the present invention, there is provided a symmetric key-based authentication in multiple domains, comprising: (a) allowing a home domain authentication server to generate a certificate and a symmetric key and to distribute the certificate and the symmetric key to an authentication entity; (b) allowing the authentication entity to submit the certificate to the home domain authentication server or an external domain authentication server; and (c) allowing the home domain authentication server or external domain authentication server to verify the validity of the submitted certificate by using the symmetric key.

In the above aspect of the present invention, the (a) may comprise: allowing the authentication entity to request the certificate to be issued; allowing the home domain authentication server to generate the symmetric key and the certificate signed by using the symmetric key; and distributing the generated certificate to the authentication entity.

In addition, where the authentication server to which the certificate is submitted is the external domain authentication server, the (c) may include allowing the external domain authentication server to verify the validity of the certificate in cooperation with the home domain authentication server, and the allowing of the external domain authentication server to verify the validity of the certificate may comprise: allowing the external domain authentication server to authenticate the home domain authentication server which issues the certificate by a public key-based authentication method; establishing a secured communication channel between the home domain authentication server and the external domain authentication server; allowing the external domain authentication server to request the home domain authentication server to verify the certificate; allowing the home domain authentication server to verify the certificate by using the generated symmetric key and transmit the result; and allowing the external domain authentication server to determine whether the authentication is successful on the basis of the result transmitted from the home domain authentication server and transmit the determination result to the authentication entity.

According to another aspect of the present invention, there is provided an authentication entity employing a multiple domain symmetric key-based authentication, the authentication entity comprising: a certificate issue request unit requesting a home domain authentication server to issue a certificate; a certificate/symmetric key receiver receiving the certificate issued by the home domain authentication server and a symmetric key in response to the certificate issue request; a certificate transmitter transmitting the certificate to the home domain authentication server or an external domain authentication server; and a certificate result receiver receiving a result of the certificate verification received from the home domain authentication server or external domain authentication server.

According to another aspect of the present invention, there is provided a home domain authentication server employing a multiple domain symmetric key-based authentication, the home domain authentication server comprising: a certificate issue request receiver receiving a certificate issue request from an authentication entity; a symmetric key/certificate generator generating a symmetric key and a certificate in response to the certificate issue request; a symmetric key/certificate issuing unit issuing the symmetric key and the certificate to the authentication entity.

In the above aspect of the present invention, in a case where the home domain authentication server verifies the authentication entity, the home domain authentication server may further comprise: a certificate verifier verifying the certificate by using the distributed symmetric key; and a certificate result transmitter transmitting the authentication verification result through the certificate verification to the authentication entity.

In addition, in a case where the external domain authentication server requests the home domain authentication server to verify the certificate and authenticates the authentication entity using the received certificate verification result received from the home domain authentication server, the home domain authentication server may further comprise: a domain communication unit which communicates with the external domain authentication server by establishing a secured communication channel with the external domain authentication server; a certificate verification request receiver receiving the certificate verification request from the external domain authentication server; a certificate verifier verifying the certificate which is requested to be verified by using the generated symmetric key; and a certificate verification result transmitter transmitting the result of the certificate verification to the external domain authentication server.

According to another aspect of the present invention, there is provided an external domain authentication server employing a multiple domain symmetric key-based authentication, wherein the external domain authentication server requests a home domain authentication server to verify the certificate received from an authentication entity and authenticates the authentication entity using the certificate verification result received from the home domain authentication server, and wherein the external domain authentication server comprising: a certificate receiver receiving the certificate submitted by the authentication entity; a domain server authentication unit authenticating the home domain authentication server using a public key authentication to establish communication channel with the home domain authentication server which has issued the certificate for verifying the certificate from the authentication entity; a domain communication unit which communicates with the home domain authentication server by establishing a secured communication channel therewith; a certificate verification requesting unit requesting the home domain authentication server to verify the certificate; a certificate verification result receiver receiving the certificate verification result from the home domain authentication server; and a certificate verification result transmitter transmitting information on whether the certification is successfully verified to the authentication entity by determining whether the certificate is verified on the basis of the result provided by the home domain authentication server.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates an authentication structure in multiple domains according to an embodiment of the present invention;

FIG. 2 illustrates a process in which an authentication entity receives a certificate and a symmetric key used for a signature from a home domain authentication server;

FIG. 3 illustrates a process in which a home domain authentication server verifies the validity of a certificate submitted by an authentication entity;

FIG. 4 illustrates a process in which an external domain authentication server verifies a certificate in cooperation with a home domain authentication server;

FIG. 5 illustrates an authentication entity according to an embodiment of the present invention cooperating with peripherals;

FIG. 6a illustrates a home domain authentication server according to an embodiment of the present invention generating a certificate and a symmetric key and transmitting the certificate and the symmetric key to an authentication entity;

FIG. 6b illustrates a home domain authentication server according to an embodiment of the present invention verifying the validity of a submitted certificate when the certificate is submitted to the home domain authentication server;

FIG. 6c illustrates a home domain authentication server according to an embodiment of the present invention, cooperating with an authentication entity and an external domain authentication server, when a certificate is submitted to the external domain authentication server; and

FIG. 7 illustrates an external domain authentication server according to an embodiment of the present invention, cooperating with an authentication entity and a home domain authentication server.

### DETAILED DESCRIPTION OF THE INVENTION

Now, preferred embodiments of the present invention will be described in detail with reference to the attached drawings.

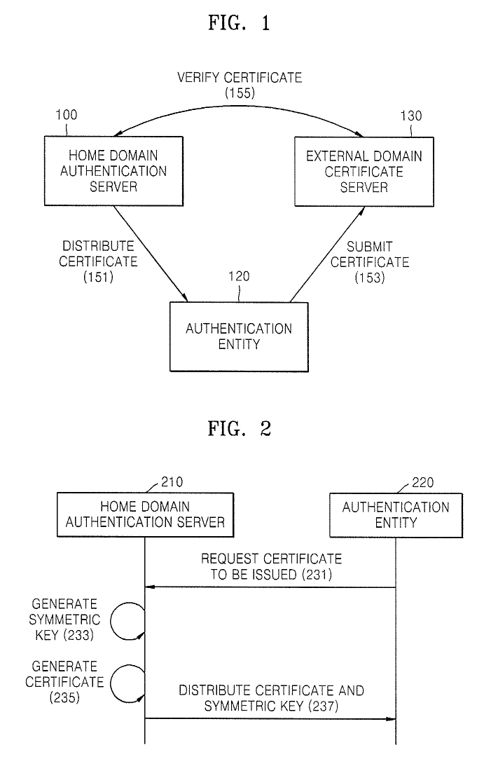

FIG. 1 illustrates an authentication structure in multiple domains according to an embodiment of the present invention.

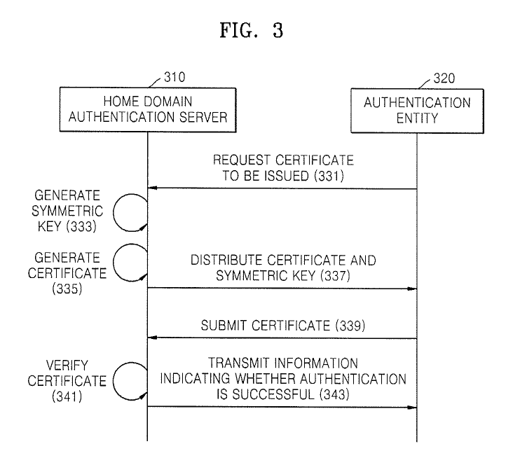

A home domain authentication server 100 generates a symmetric key and a certificate and distributes the symmetric key and the certificate to an authentication entity 120. The authentication entity submits the certificate to an external domain authentication server 130 for authentication (operation 153). The external domain authentication server 130, which receives the certificate, performs a mutual authentication process in cooperation with the home domain authentication server 100 by using an existing public key-based authentication method, so as to verify the certificate. Then, the external domain authentication server receives the result of the certificate verification through an established communication channel and transmits the result to the authentication entity 120. Processes of the embodiment of the present invention of FIG. 1 will be more specifically described with reference to FIGS. 2 to 4.

FIG. 2 illustrates a process in which an authentication entity receives a certificate and a symmetric key used for a signature from a home domain authentication server. That is, FIG. 2 more specifically illustrates a process of distributing a certificate (operation 151) shown in FIG. 1.

First, an authentication entity 220 requests a home domain authentication server 210 to issue a certificate (operation 231). The home domain authentication server 210 which is requested to issue the certificate generates a symmetric key (operation 233) and generates a signed certificate by using the generated symmetric key (operation 235). The generated certificate and the symmetric key are distributed to the authentication entity which requested the certificate to be issued.

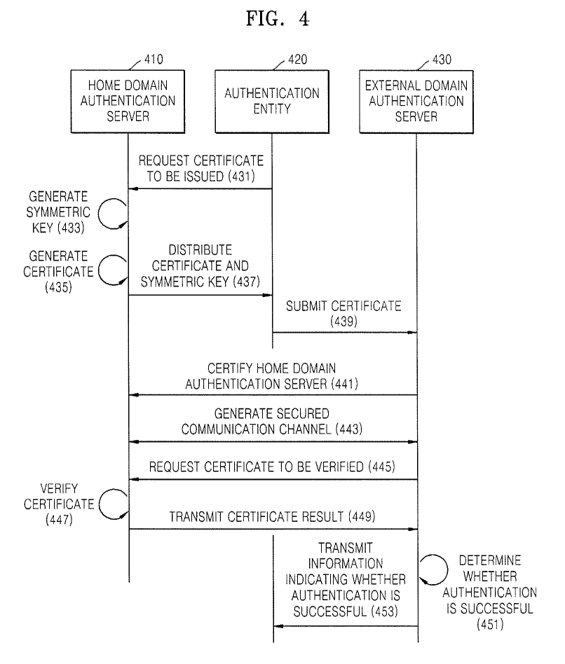

FIG. 3 illustrates a process in which a home domain authentication server verifies the validity of a certificate submitted by an authentication entity.

When an authentication entity 320 submits a certificate to a home domain authentication server 310, the home domain authentication server verifies the certificate. The authentication entity 320 requests a certificate to be issued through the process shown in FIG. 2. Similarly, the home domain authentication server 310 generates a symmetric key (operation 333) and a certificate (operation 335) and distributes the certificate and the symmetric key to the authentication entity 320 (operation 337). When the authentication entity 320 submits the certificate to the home domain authentication server 310, the home domain authentication server 310 verifies the certificate by using the predetermined symmetric key (operation 341) and transmits information indicating whether the authentication process is successful (operation 343).

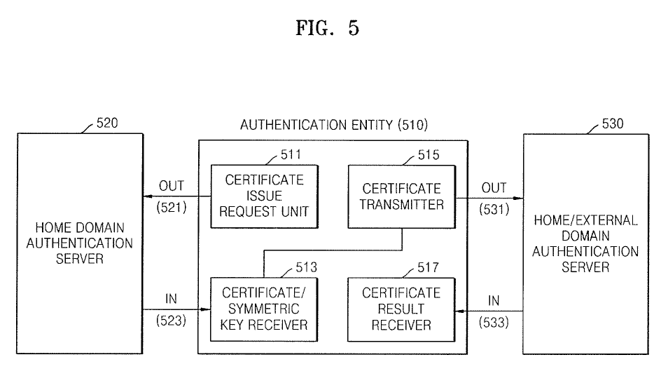

FIG. 4 illustrates a process in which an external domain authentication server verifies a certificate in cooperation with a home domain authentication server.

In FIG. 4, processes of the present invention will be described in detail with respect to all the processes of FIG. 1. As described above, the operation of requesting a certificate to be issued (operation 431), the operation of generating a symmetric key (operation 433), an operation of generating a certificate (operation 435), and an operation of distributing the certificate and the symmetric key (operation 437) are performed through the same processes as those shown in FIG. 1.

The authentication entity 420 submits the certificate received from the home domain authentication server 410 to the external domain authentication server 430 and waits for the result of the certificate verification. In order to verify the certificate, the external domain authentication server 430 which receives the certificate establishes a communication channel so as to communicate information with the home domain authentication server 410 which issued the certificate. That is, the external domain authentication server 430 performs a mutual authentication process in cooperation with the home domain authentication server by using an existing public key-based authentication method (operation 441).

After the authentication process of the home domain authentication server is performed through the public key-based authentication method, a secured communication channel is established between the home domain authentication server 410 and the external domain authentication server 430 (operation 443), and accordingly a free communication environment is established therebetween. Then, the external domain authentication server 430 requests the home domain authentication server 410 to verify the certificate so as to verify the certificate received from the authentication entity 420 (operation 445).

The home domain authentication server 410 which receives the certificate verification request verifies the certificate by using the generated symmetric key (operation 447), transmits the certificate result to the external domain authentication server (operation 449), and completes a security session. The external domain authentication server 430 which receives the certificate verification result determines whether the authentication is successful (operation 451) and transmits information indicating whether the authentication is successful. Then all the processes are completed.

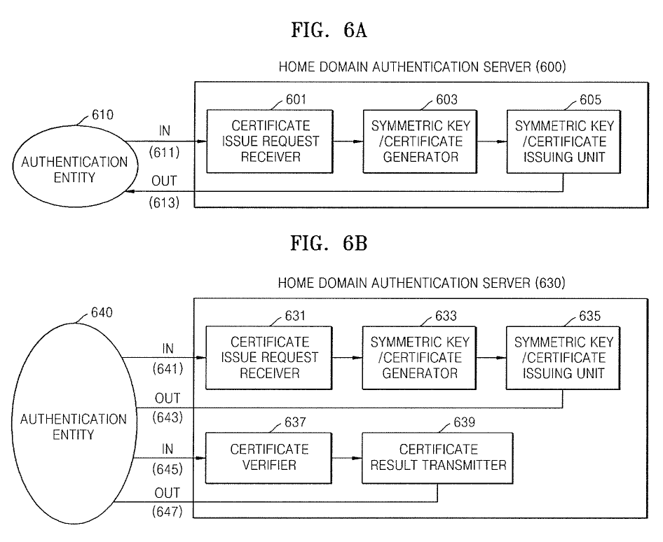

Referring to FIG. 5, an authentication entity 510 according to an embodiment of the present invention cooperates with a home domain authentication server 520 and home/external domain authentication server 530.

The authentication entity 510 includes an authentication issue requesting unit 511 which requests the home domain authentication server 520 to issue a certificate (operation 521) and a certificate/symmetric key receiver 513 which receives the certificate and the symmetric key from the home domain authentication server 520 (operation 523). The authentication entity 510 further includes a certificate transmitter 515 which submits the received certificate to the home domain authentication server or external domain authentication server 530 and a certificate result receiver 517 which receives the certificate verification result.

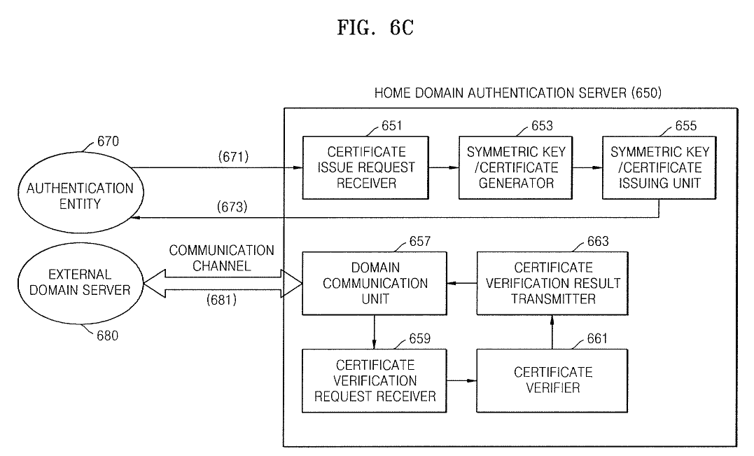

FIGS. 6a to 6c illustrate a home domain authentication server according to an embodiment of the present invention in accordance with additional functions.

In FIG. 6a, a device responding to the authentication entity's request of issuance of a certificate (operation 521) is illustrated. The home domain authentication server 600 includes a certificate issue request receiver 601 which receives a certificate issue request in response to the certificate issuing request 611, a symmetric key/certificate generator 603 which generates a symmetric key and a certificate in response to the certificate issue request, and a symmetric key/certificate issuing unit 605 which issues the generated symmetric key and the certificate to the authentication entity 610.

FIG. 6b illustrates a home domain authentication server 630 including additional components when the authentication entity submits a certificate, and the certificate has to be verified, in addition to the components of FIG. 6a.

The home domain authentication server 630 further includes a certificate verifier 637 which verifies the certificate received from the authentication entity 640 and a certificate result transmitter 639 which transmits the authentication verification result through the certificate verification to the authentication entity 640, in addition to the components of the home domain authentication server 600 of FIG. 6a.

FIG. 6c illustrates a home domain authentication server 650 including additional components when the external domain server 680 requests the certificate to be verified.

The home domain authentication server 650, in addition to the components of the home domain authentication server 600 of FIG. 6a, further includes a domain communication unit 657 communicating with an external server by establishing a communication channel 681 between the home domain authentication server and an external domain server such as the external domain server 680, a certificate verification request receiver 659, which receives a certificate verification request from an external domain server, the certificate verification verifier 661 which verifies the certificate requested to be verified using the predetermined symmetric key and a certificate verification result transmitter 663 that transmits the result of the certificate verification to the external domain server 680. The certificate verification result transmitter 663 transmits the verification result through the domain communication unit 657 so as to transmit the verification result to the external domain server.

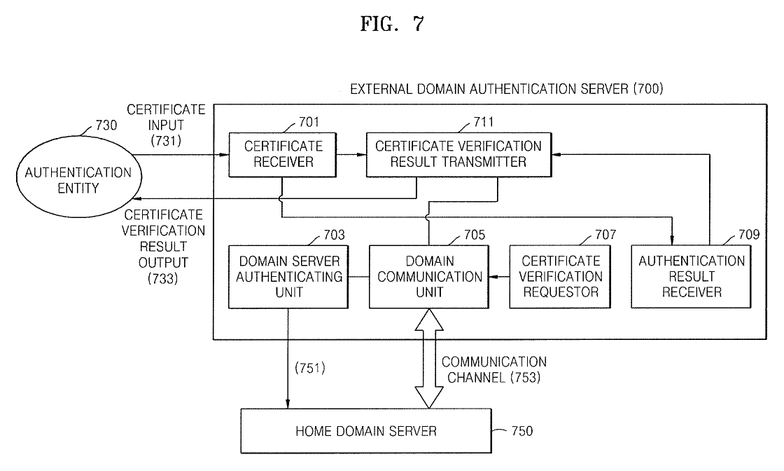

FIG. 7 illustrates the external domain authentication server and its operation cooperating with a home domain authentication server 700 and an authentication entity 730 according to an embodiment of the present invention.

An external domain authentication server 700 includes a certificate receiver 701 which receives the certificate submitted by the authentication entity 730. In order to verify the certificate received from the certificate receiver 701, the external domain authentication server 700 establishes a communication channel with a home domain server 750 in response to a request of a certificate verification requester 707. In order to establish the communication channel, the external domain authentication server 700 includes a domain server authenticating unit 703 which authenticates the home domain server 750 by using an existing public key-based authentication method and generates a secured communication channel 753 through a domain communication channel 705 by distributing a session key. The external domain authentication server 700 requests the certificate of the authentication entity to be verified through the established communication channel. The home domain server 750 transmits the result after the validity of the certificate is verified through the symmetric key used for the certificate signature and completes the security session. The certificate verification result received from the established communication channel 705 is transmitted to the certificate verification result receiver 709. The certificate verification result receiver 709 transmits the verification result to the certificate verification result transmitter 711. The certificate verification result transmitter 711 transmits the certificate verification result to the authentication entity 730.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

As described above, the symmetric key-based authentication method in multiple domains according to an embodiment of the present invention employs a symmetric key-based authentication method which is relatively simple and light-weighted as compared with a public key authentication method which needs a high level computing capability and a complicated password process. At the same time, it is possible to select various devices in a ubiquitous computing environment or home network environment by solving scalability, which is a problem of the symmetric key-based method, and solving a key management problem.

What is claimed is:

1. A symmetric key-based authentication method in multiple domains, the method comprising:
(a) allowing a home domain authentication server to generate a certificate and a symmetric key and to distribute the certificate and the symmetric key to an authentication entity;
(b) allowing the authentication entity to submit the certificate to the home domain authentication server or an external domain authentication server; and
(c) allowing the home domain authentication server or external domain authentication server to verify the validity of the submitted certificate by using the symmetric key.

2. The method of claim 1, wherein (a) comprises:
allowing the authentication entity to request the certificate to be issued;
allowing the home domain authentication server to generate the symmetric key and the certificate signed by using the symmetric key; and
presenting the generated certificate to the authentication entity.

3. The method of claim 1,
wherein the authentication server to which the certificate is submitted is the external domain authentication server,
wherein (c) includes allowing the external domain authentication server to verify the validity of the certificate in cooperation with the home domain authentication server, and
wherein the allowing of the external domain authentication server to verify the validity of the certificate comprises:
allowing the external domain authentication server to authenticate the home domain authentication server which issues the certificate by a public key-based authentication method;
establishing a secured communication channel between the home domain authentication server and the external domain authentication server;
allowing the external domain authentication server to request the home domain authentication server to verify the certificate;
allowing the home domain authentication server to verify the certificate by using the generated symmetric key and transmit the result; and
allowing the external domain authentication server to determine whether the authentication is successful on the basis of the result transmitted from the home domain authentication server and transmit the determination result to the authentication entity.

4. An authentication entity employing a multiple domain symmetric key-based authentication, the authentication entity comprising:
a certificate issue request unit requesting a home domain authentication server to issue a certificate;
a certificate/symmetric key receiver receiving the certificate issued by the home domain authentication server and a symmetric key in response to the certificate issue request;
a certificate transmitter transmitting the certificate to the home domain authentication server or an external domain authentication server; and
a certificate result receiver receiving a result of the certificate verification received from the home domain authentication server or external domain authentication server.

5. A home domain authentication server employing a multiple domain symmetric key-based authentication, the home domain authentication server comprising:
a certificate issue request receiver receiving a certificate issue request from an authentication entity;
a symmetric key/certificate generator generating a symmetric key and a certificate in response to the certificate issue request; and
a symmetric key/certificate issuing unit issuing the symmetric key and the certificate to the authentication entity.

6. The home domain authentication server of claim 5,
wherein the home domain authentication server verifies the authentication entity, and
wherein the home domain authentication server further comprises:
a certificate verifier verifying the certificate by using the distributed symmetric key; and
a certificate result transmitter transmitting the authentication verification result through the certificate verification to the authentication entity.

7. The home domain authentication server of claim 5,
wherein the external domain authentication server requests the home domain authentication server to verify the certificate and authenticates the authentication entity using the certificate verification result received from the home domain authentication server, and
wherein the home domain authentication server further comprises:
a domain communication unit which communicates with the external domain authentication server by establishing a secured communication channel with the external domain authentication server;
a certificate verification request receiver receiving the certificate verification request from the external domain authentication server;
a certificate verifier verifying the certificate which is requested to be verified by using the generated symmetric key; and
a certificate verification result transmitter transmitting the result of the certificate verification to the external domain authentication server.

8. An external domain authentication server employing a multiple domain symmetric key-based authentication,
wherein the external domain authentication server requests a home domain authentication server to verify the certificate received from an authentication entity and authenticates the authentication entity using the certificate verification result received from the home domain authentication server, and
wherein the external domain authentication server comprises:
a certificate receiver receiving the certificate submitted by the authentication entity;
a domain server authentication unit authenticating the home domain authentication server using a public key authentication to establish communication channel with the home domain authentication server which has issued the certificate for verifying the certificate received from the authentication entity
a domain communication unit which communicates with the home domain authentication server by establishing a secured communication channel therewith;
a certificate verification request unit requesting the home domain authentication server to verify the certificate;
a certificate verification result receiver receiving the certificate verification result from the home domain authentication server; and
a certificate verification result transmitter transmitting information on whether the certification is successfully verified to the authentication entity by determining whether the certificate is verified on the basis of the result provided by the home domain authentication server.
